(19) United States
(12) Patent Application Publication
(10) Pub. No.: US 2008/0173506 A1
(43) Pub. Date: Jul. 24, 2008

(54) Opening and closing mechanism with damper

(76) Inventors: Hiroshi Ohno, Itabashi Ward (JP); Nobutaka Yajima, Itabashi Ward (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,549

(22) Filed: Jan. 11, 2008

Related U.S. Application Data
(62) Division of application No. 11/237,914, filed on Sep. 29, 2005.

(30) Foreign Application Priority Data
Oct. 18, 2004 (JP) 2004-302984

(51) Int. Cl. F16F 9/14

(52) U.S. Cl. 188/290

(57) ABSTRACT

An opening and closing member with a rotary damper for use in a western style stool or piano and the like which facilitates easy control of the rotary damper and easy assembly. Hinge members corresponding to an opening and closing member side are adjacently disposed at the same side of respective hinge members on a side of a proper member. The rotary damper having a particular directivity is disposed between hinge members facing each other. The opening and closing member is swivellably journalled on the proper member about an axis of rotation of the rotary dampers, and the damping power of the rotary damper is applied to the swiveling motion as the opening and closing member swivels with the rotary damper on its axis.

### BACKGROUND OF THE INVENTION

The present invention relates to an opening and closing mechanism with a damper for use in a western style stool or piano.

Heretofore, as shown in FIG. 5, in the western style stool, a pair of hinge elements 4, 6 is provided at the side of the stool proper member 2, and a pair of hinge members 10, 12 is provided at the side of an opening and closing member 8 of a lavatory seat or lavatory lid. Hinge member 10 is disposed at the right side of hinge element 4 of the stool proper member 2. Hinge member 12 is disposed at the left side of hinge element 6. Hinge element 4 and hinge member 10, and hinge element 6 and hinge member 12 are connected by rotary dampers 14 and 16, respectively. The damping power of rotary members 14, 16 has a direction property of asymmetry type which was disclosed in the official gazette of Japanese Patent Kokai H-10-20167 70.

In FIG. 5, a mounting member 14b with rotation skid face is formed on a cylindrical housing 14a of rotary damper 14. Mounting member 14b is tied to a mounting portion 4a with rotation skid face that is formed on the side of hinge element 4. A mounting member 14d with rotation skid face is formed on an axial portion of a rotary member 14c which projects from housing 14a, and mounting member 14d is tied to mounting portion 10a with rotation skid face formed on the side of hinge member 10.

A relationship between rotary damper 16, hinge element 6, and hinge member 12 resembles the mounting structure mentioned above. Rotary dampers 14 and 16 are disposed on an identical axis and are disposed on the left and right sides, respectively, of the opening and closing mechanism shown in FIG. 5.

As shown in FIG. 5, a construction is illustrated wherein hinge members 10 and 12 are disposed at different sides of hinge elements 4 and 6, respectively. Hinge element 4 and hinge member 10, and hinge element 6 and hinge member 12 are of a bilateral symmetry. However, rotary damper 14 disposed between hinge element 4 and hinge member 10 and rotary damper 16 disposed between hinge element 6 and hinge member 12, end up with a relationship whose relative rotating direction against the housing of the rotary member is reversed.

Namely, in FIG. 5, when the cover portion (illustration is omitted) of opening and closing member 8 is swiveled about rotary dampers 14 and 16 to a standing up position from the cover closed position where it extends perpendicular to the page, rotary member 14c rotates in a clockwise direction relative to housing 14a, and rotary member 16c rotates in a counterclockwise direction relative to housing 16a.

Accordingly, when a rotary damper whose damping power is of asymmetric type is used, two kinds of rotary damper are required, one whose damping direction is for clockwise rotation and another whose damping direction is for counterclockwise rotation. For this reason, control of component parts becomes complicated, and moreover, mass production cannot be expected. Furthermore, in the case of mounting the rotary damper, when two rotary dampers of different types are erroneously installed in each other's proper locations, the proper rotation cannot be transmitted to the rotary damper and the desired damping characteristic cannot be obtained.

An object of the present invention is to solve the foregoing problems.

### SUMMARY OF THE INVENTION

In one aspect of the invention, at least two hinge elements are provided at the side of a proper member and are separated by a predetermined interval. At least two hinge members are provided on an opening and closing member side and correspond to each of the hinge elements. Each of the hinge members is disposed in opposition to the same side of the respective hinge element. A mounting member for a rotary damper is provided at each hinge member. The rotary damper has asymmetric damping power, mounting members at both ends, and is disposed between the hinge elements of the proper member and the hinge members of the opening and closing member which are disposed in opposition. The mounting member at one side of the rotary damper is tied to the mounting portion provided at a hinge element of the proper member, and the mounting member of the other side of the rotary damper is tied to the mounting portion provided on a hinge member of the opening and closing member. In the foregoing construction, the opening and closing member is swivelly journalled at the proper member with the axis of rotary damper 30 as a rotation center, and the damping power of the rotary damper is applied to the swiveling motion of the opening and closing member with the rotary damper as the pivot.

Furthermore, the present invention is constructed such that the rotary damper is composed of a cylindrical housing and a rotary member rotatably housed in the housing that rotates relative to the housing. A mounting member of the rotary damper is formed at an end portion of the housing, and another mounting member of the rotary damper is formed at another end portion of the housing. The shape of the mounting member at one end of the rotary damper and of the mounting member at the other end is symmetric.

The present invention is constructed such that during operation each of a plurality of dampers rotates in the same direction regardless of orientation. It should be appreciated that using one kind of rotary damper is sufficient for achieving the objects of the invention, and that using one kind of rotary damper facilitates easier control of component parts and facilitates mass production of the opening and closing mechanism.

Furthermore, during assembly, there is no apprehension of making a mistake with respect to the mounting positions of the right and left rotary dampers, and as a result, the assembly process can be efficiently carried out.

Moreover, during assembly, workers may disregard the fitting directions of the rotary dampers which facilitates efficient assembly of the opening and closing mechanism.

### BRIEF DESCRIPTION OF THE DRAWINGS

FIG. 1 is a cross-sectional view showing an embodiment of the present invention.

FIGS. 2A, 2B, and 2C are a plan view, a left end view and a right end view, respectively, of an explanatory drawing of an appearance of the rotary damper.

FIGS. 3A-3D are sectional views illustrating the operation of the rotary damper.

FIG. 4 is a cross-sectional view showing another embodiment of the present invention.

FIG. 5 is a cross-sectional view of a conventional opening and closing mechanism.

### DETAILED DESCRIPTION OF THE INVENTION

The present invention will be described in detail by referring to the attached drawings. In FIG. 1, reference numeral 18 denotes a proper member composed of proper members such as a western style stool or piano and a variety of storage boxes with a lid or cover. Hinge elements 22, 24 consist of projecting members. The hinge elements 22 and 24 are provided on proper member 18 at locations corresponding to attachment locations of an opening and closing member 20. Opening and closing member 20 may be, for example, a stool seat or a stool lid of proper member 18 or a lid of a piano. The attachment locations are spaced at a predetermined interval.

In the exemplary embodiment, two hinge elements 22 and 24 are provided. However, it should be appreciated that more than two hinge elements may be provided in other embodiments. Hinge members 26 and 28 are formed on opening and closing member 20, are separated by a predetermined interval, and are in correspondence to hinge elements 22 and 24 of the proper member 18. The hinge members 26 and 28 of opening and closing member 20 are disposed adjacent to the left sides S1 and S2 of hinge elements 22 and 24, respectively. It should be understood that in other embodiments, hinge members 26 and 28 of opening and closing member 20 may be arranged adjacent to the right sides of hinge elements 22 and 24, respectively.

Housing storing portions 34 and 36, and 38 and 40, store a cylindrical housing 30a of a rotary damper 30. Housing storing portions 34 and 36 are bored in hinge element 22 and hinge member 26, respectively. Likewise, housing storing portions 38 and 40 are bored in hinge element 24 and hinge member 28, respectively. Housing storing portions 34 and 36 are adjacent and opposed to each other about an identical axis. Similarly, housing storing portions 38 and 40 are adjacent and opposed to each other about the identical axis.

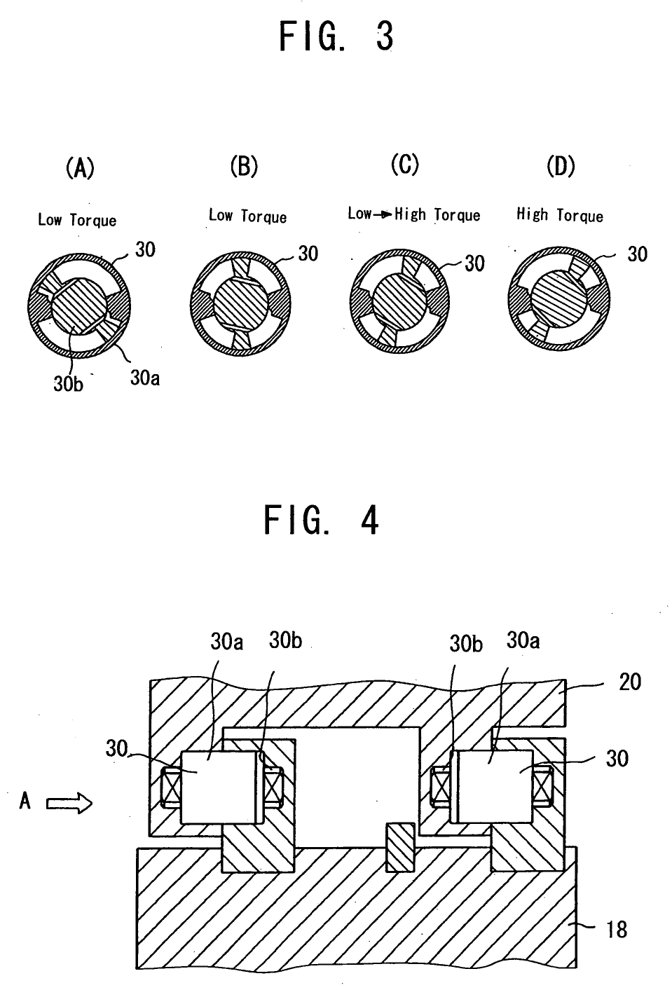

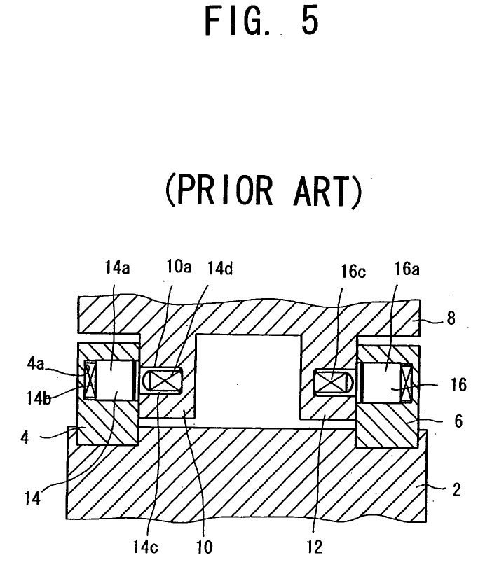

Furthermore, damper mounting portions 22a and 26a have mutually identical shapes with rotation skid faces, and are bored in housing storage portions 34 and 36, respectively. Likewise, damper mounting portions 24a and 28a have mutually identical shapes with rotation skid faces, and are bored in housing storage portions 38 and 40, respectively. Damper mounting portions 22a and 26a, and 24a and 28a, are bored to align on the identical axis. Damper mounting portions 22a and 24a open to sides S1 and S2, respectively, of hinge elements 22 and 24. Damper mounting portions 26a and 28a open to sides S3 and S4, respectively, of hinge members 26 and 28. Rotary damper 30 is mounted from these open sides. Each rotary damper 30 is composed of a housing 30a of a cylindrical type that is filled with oil, and a rotary member 30b that fits rotatably in housing 30a. In the exemplary embodiment, rotary damper 30 is an asymmetrical type rotary damper that outputs different damping characteristics determined by the rotating direction of a structure illustrated in FIG. 3. The asymmetrical type rotary damper has damping power that works on the load by a relative rotating direction of rotary member 30b against housing 30a. The asymmetrical type rotary damper 30 has torque working on rotary housing 30a that changes sequentially from a first low torque to a second low torque, from the second low torque to a first high torque, and then from the first high torque to a second high torque as shown in FIGS. 3(A), 3(B), 3(C) and 3(D), respectively. Rotary member 30b makes a relative rotation from an initial position shown in FIG. 3A clockwise against housing 30a.

When rotary member 30b rotates relative to rotary housing 30a counterclockwise against housing 30a from the second high torque shown in FIG. 3D, the torque working on rotary member 30b sequentially changes from the second high torque shown in FIG. 3D, to the first high torque shown in FIG. 3C, to the second low torque shown in FIG. 3B, and to the first low torque shown in FIG. 3A. The internal structure of the asymmetric type rotary damper 30 as shown in FIG. 3 is disclosed in the official gazette of Japanese patent laid open publication (TOKKAI) 2001-349364, and is hitherto open to the public, and moreover, the present invention is not particularly limited to the rotary damper housing of the internal structure shown in FIG. 3 so that its detailed description is omitted.

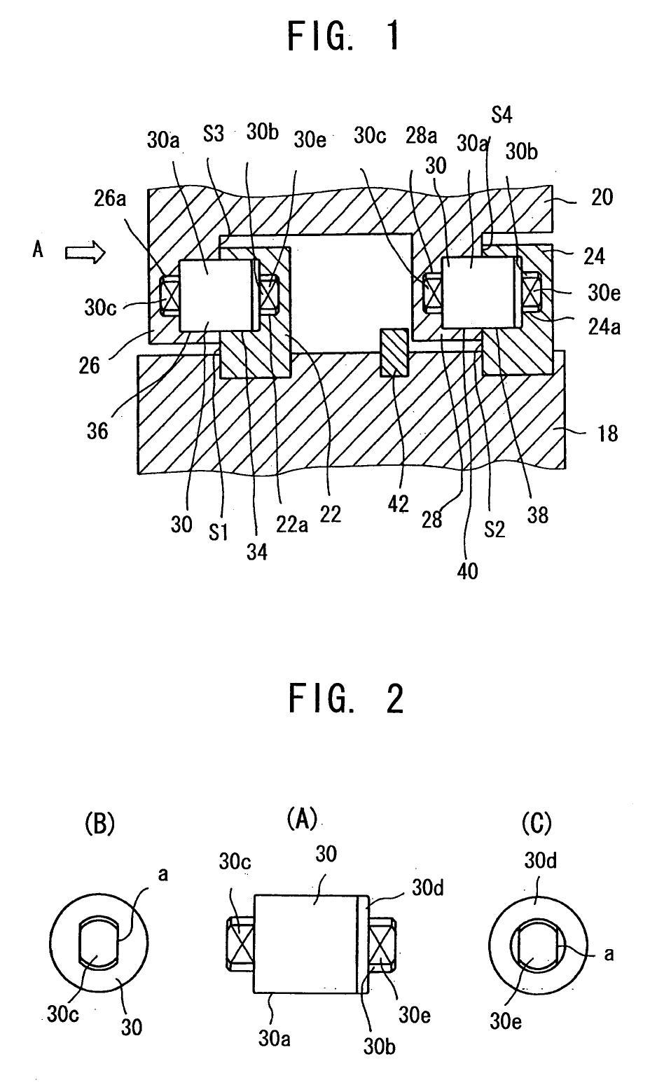

In the exemplary embodiment, each rotary damper 30 includes mounting members 30c and 30e that are axially positioned at the left and right sides, respectively, of housing 30a, as shown in FIG. 2A. Thus configured, housing 30a and mounting members 30c and 30e form a bilaterally symmetric rotary damper 30. Mounting members 30c and 30e are identically shaped, include an axial skid face “a”, and rotate on the identical axis of housing 30a. It should be appreciated that each housing 30a includes a viscous fluid for producing a damping effect and includes a cap 30d.

Each housing 30a is rotatably fitted and disposed in housing storing portions 34 and 36, and 38 and 40. Specifically, mounting members 30c and 30e are fitted, disposed on, and tied to corresponding mounting portions 26a and 22a, and 28a and 24a, respectively. A stopper 42 is positioned on proper member 18 proximate a left side of hinge member 28 to prevent opening and closing member 20 from moving left towards hinge element 22.

In the foregoing construction, when the lid portion (illustration omitted) of opening and closing member 20 is swiveled to open from a closed position where it is oriented perpendicular to the page of FIG. 1, it rotates counterclockwise about hinge elements 22 and 24 as viewed from the arrow mark direction A of FIG. 1. At this time, housing 30a of rotary damper 30 on the left side rotates counterclockwise relative to left side rotary member 30b. Similarly, housing 30a of rotary damper 30 on the right side rotates counterclockwise relative to right side rotary member 30b. As a result, the rotating directions of rotary dampers 30 of the right and left sides is identical.

For this reason, the same kind of asymmetric type rotary damper 30 can be used for the right and left side hinge members 26 and 28, respectively. Rotary dampers 30 are mounted on the right and left sides of FIG. 1, respectively. Rotary dampers 30 are mounted in hinge elements 22 and 24 such that each mounting member 30e is oriented on the right side of each damper 30 and is positioned within one of mounting portions 22a and 24a. Similarly, each mounting member 30c is oriented on the left side of each damper 30 and is positioned within one of mounting portions 26a and 28a. However, it should be appreciated that dampers 30 may be oriented differently by rotating them through one-hundred-eighty degrees such that mounting members 30c and 30e face in opposite directions. That is, mounting members 30c and 30e face in left and right directions of FIG. 1, respectively. Thus, the orientation of dampers 30 is optional.

FIG. 4 shows an alternative embodiment of the opening and closing mechanism. Specifically, the opening and closing mechanism includes left and right side rotary dampers 30 mounted such that the left side rotary damper 30 is oriented to have mounting members 30c face left and mounting member 30e face right, and such that the right side rotary damper 30 is rotated one-hundred-eighty degrees such that mounting member 30c faces right and mounting member 30e faces left. In this alternative embodiment, when opening and closing member 20 is swiveled open from the closed position, rotary member 30b of right side rotary damper 30 rotates counterclockwise as viewed from the arrow mark direction A. Moreover, housing 30a of the right side rotary damper 30 rotates counterclockwise relative to rotary member 30b, and as a result, the left and right side rotary dampers 30 rotate in identical directions. Consequently, during assembly, workers have the option of installing or mounting right and left side rotary dampers 30 in more than one orientation between hinge element 22 and hinge member 26, and between hinge element 24 and hinge member 28, respectively. The asymmetric type rotary dampers 30 to be used in this invention are such as the rotary damper disclosed in the Japanese official gazette of publicly known TOKKAI H-282039 or other types such as the rotary dampers of a structure with different torque characteristics depending on the rotating direction.

It should be appreciated that although the exemplary embodiments describe rotary dampers 30 as having bilateral symmetry, in other embodiments, rotary dampers 30 are not limited to the embodiment of a bilateral symmetry. In another alternative embodiment, mounting members 30c and 30e are of different shape, mounting portions 26a and 28a are formed so as to be suitable for the shape of mounting member 30c, and mounting portions 22a and 24a are formed so as to be suitable for the shape of mounting member 30e.

In yet another alternative embodiment, mounting members 30c and 30e are formed in a different shape, mounting portions 22a and 24a are formed in a different shape, and mounting portions 26a and 28a may be formed in a structure suitable to the shape of the mounting member 30e. Furthermore, mounting member 30c may be shaped to a shape suitable for any of the mounting portions 22a, 24a, 26a, 28a. If mounting member 30e has a shape suitable for any of mounting portions 22a, 24a, 26a, 28a, the same operation and effect identical with the case of using rotary damper 30 wherein mounting member 30c and mounting member 30e, shown in FIG. 2 are identical, can be obtained, although mounting member 30c and mounting member 30e are not necessarily of identical shape. Furthermore, in this case, mounting member 30c and mounting member 30e of mutually different shapes may be made suitable for any of mounting portions 22a, 24a, 26a 28a with the use of adapters and the like.

### CROSS REFERENCE TO RELATED APPLICATION

This application is a divisional of Application No. 11/237,914, filed Sep. 29, 2005.

1-3. (canceled)

4. A rotary damper for applying an asymmetric braking force during rotation when an opening and closing member is rotated relative to a proper member, the opening and closing member being rotatably coupled to the proper member such that the opening and closing member is capable of rotating freely relative to the proper member, the rotary damper comprising:
a first mounting member;
a second mounting member;
a cylindrical housing; and
a damper rotary member to be connected to the first mounting member,
wherein the damper rotary member is rotatably positioned in the cylindrical housing and is rotatably connected to the cylindrical housing, the first mounting member extends from one end of the cylindrical housing and the second mounting member extends from another end of the cylindrical housing, and the shape of the first mounting member is the same as that of the second mounting member, and the rotary damper is symmetric,
wherein the first mounting member is capable of being attached to a mounting portion of either the proper member or the opening and closing member, and the second mounting member is capable of being attached to the mounting portion of either the proper member or the opening and closing member.
